(19) United States
(12) Patent Application Publication
(10) Pub. No.: US 2021/0395430 A1
(43) Pub. Date: Dec. 23, 2021

(54) PROCESS FOR PREPARING PREPOLYMERS THAT COMPRISE A POLYOXYMETHLYENE BLOCK

(71) Applicant: Covestro Intellectual Property GmbH & Co. KG, Leverkusen (DE)

(72) Inventors: Jens Langanke, Mechernich (DE); Christoph Guertler, Köln (DE); Ghazi Ghattas, Eschweiler (DE); Philipp von Tiedemann, Rosenheim (DE); Christoph Rosorius, Ratingen (DE); Walter Leitner, Aachen (DE)

(21) Appl. No.: 17/288,658

(22) PCT Filed: Nov. 14, 2019
(86) PCT No.: PCT/EP2019/081405

§ 371 Date: Apr. 26, 2021

(30) Foreign Application Priority Data
Nov. 16, 2018 (EP) 18206860.1

(51) Int. Cl. C08G 18/10; C08G 18/48; C08G 18/73; C08G 18/76; C08G 18/75; C08G 18/08

(52) U.S. Cl. CPC C08G 18/10; C08G 18/4825; C08G 18/0852; C08G 18/7621; C08G 18/755; C08G 18/73

(57) ABSTRACT

The invention relates to a process for preparing prepolymers that comprise a polyoxymethylene block. The invention also relates to prepolymers that can be obtained by said process and to mixtures of the prepolymers with OH-reactive compounds, preferably polyisocyanates. The invention further relates to a chemical-technical process for preparing a chemical product of defined composition.

The present invention describes a process for preparing prepolymers comprising a polyoxymethylene block. It further relates to prepolymers obtainable by such a process and to mixtures of these prepolymers with OH-reactive compounds, preferably polyisocyanates.

Block copolymers containing polyoxymethylene units in addition to other polymer and polycondensate units are described, for example, in JP 2007 211082 A, WO 2004/096746 A1, GB 807589, EP 1 418 190 A1, U.S. Pat. Nos. 3,754,053, 3,575,930, US 2002/0016395, EP 3 129 419 B1 and JP 04-306215.

Langanke et al., in Journal of Polymer Science, Part A: Polymer Chemistry (2015), 53(18), 2071-2074, describes the synthesis of formaldehyde-based polyether(carbonate)polyols and the economic and ecological advantages of utilizing polyacetals such as paraformaldehyde.

U.S. Pat. No. 3,575,930 A describes a process for preparing NCO prepolymers, characterized in that they are preparable by reacting low molecular weight pFA (n=2-64) with diisocyanates in excess. The low molecular weight pFA fractions are obtained by extraction with boiling dioxane (b.p. 101° C.) and subsequent filtration and are not storable. An energy-intensive azeotropic distillation step with benzene is moreover necessary to remove water from the low molecular weight pFA fractions in solution. In addition, the described azeotropic distillation and the reaction of pFA with diisocyanates are carried out at relatively high temperatures, and decomposition reactions to form considerable amounts of monomeric formaldehyde therefore take place.

WO 2004/096746 discloses the reaction of formaldehyde oligomers with alkylene oxides and/or isocyanates. In this method the described use of formaldehyde oligomers HO—(CH₂O)ₙ—H affords polyoxymethylene block copolymers having a relatively narrow molar mass distribution of n=2-19, an additional thermal removal process step being required for the provision of the formaldehyde oligomers from aqueous formalin solution. The obtained formaldehyde oligomer solutions are not storage-stable and therefore require immediate subsequent further processing.

WO 2014/095679 A1 describes a process for preparing NCO-modified polyoxymethylene block copolymers comprising the step of polymerizing formaldehyde in a reaction vessel in the presence of a catalyst, wherein the polymerization of formaldehyde is moreover carried out in the presence of a starter compound having at least 2 Zerewitinoff-active H atoms to obtain an intermediate and said intermediate is reacted with an isocyanate.

In unpublished application EP 17206871.0 is a process for preparing a prepolymer containing polyoxymethylene groups, comprising the step of reacting a polyol component with a compound reactive toward OH groups, wherein the polyol component comprises a polyoxymethylene containing OH end groups where said OH end groups are not part of carboxyl groups. The reaction is performed in the presence of an ionic fluorine compound, wherein the ionic fluorine compound is a coordinatively saturated compound. The disadvantage of this procedure is that fluorine compounds must be removed prior to the conversion of the prepolymers into polyurethane foams since they can adversely affect foaming reactions.

In the prior art to date the conversion of polymeric formaldehyde is performed either at relatively high temperatures, with onset of depolymerization of the polymeric formaldehyde compounds, or in some cases, to improve the dissolution characteristics of the poorly soluble polymeric formaldehyde, additional fluorine-containing compounds must be added as a solubilizer which can disrupt subsequent reactions such as for example the polyurethanization reaction and requires separation of an additional process step.

Proceeding from the prior art the object was to provide a simple and thermally mild process for converting poorly soluble polymeric formaldehydes into industrially processable and defined reactive prepolymer compounds, preferably NCO-terminated prepolymers, without addition of unnecessary solubilizers, so that the compounds are not only chemically stable and thus storable but also directly convertible in downstream descendant reactions such as for example polyurethanization reactions. A further aspect of the process according to the invention is the reduction of solvent requirements.

This object is achieved according to the invention by a process for preparing a prepolymer comprising a polyoxymethylene block, wherein the process comprises the steps of:

i) preparing a formaldehyde solution (a) by adding a solvent to polymeric formaldehyde in a first container;

ii) withdrawing the formaldehyde solution prepared in step i) from the first container and transferring it to a second container containing OH-reactive compound to form a solution (b) containing the prepolymer;

iii) distillatively recycling the solvent from the second container to the first container;

wherein the polymeric formaldehyde has m terminal hydroxyl groups;

wherein m is a natural number of two or more, wherein the OH-reactive compound has m or more terminal OH-reactive groups;

wherein the solvent contains no OH-reactive functional groups and does not itself react with OH-reactive compounds;

wherein the solution (b) in step ii) has a temperature in the second container of not more than 80° C., preferably not more than 70° C. and particularly preferably not more than 60° C.;

and wherein the temperature of the formaldehyde solution (a) in the first container in step i) is not more than the temperature of the solution (b) in the second container.

The use of the word “a” in connection with countable parameters should be understood here and hereinafter to mean the number one only when this is evident from the context (for example through the wording “precisely one”). Otherwise, expressions such as “a polymeric formaldehyde compound” etc. always also encompass such embodiments in which two or more polymeric formaldehyde compounds etc. are used.

The invention is elucidated in detail hereinbelow. Various embodiments may be combined with one another as desired unless the opposite is clearly apparent to a person skilled in the art from the context.

In the context of the invention “prepolymers comprising a polyoxymethylene block” are to be understood as meaning polymeric compounds containing at least one polyoxymethylene block and at least one additional molecular unit (for example urethane molecule with additional isocyanate (NCO) functionality).

### Formaldehyde

The process according to the invention employs polymeric formaldehyde, wherein the formaldehyde has m terminal hydroxyl group and m is a natural number of two or more, preferably of 2 or 3.

Suitable polymeric formaldehydes for the process according to the invention are in principle oligomeric and polymeric forms of formaldehyde having at least two terminal hydroxyl groups for reaction with the OH-reactive groups of an OH-reactive compound. According to the invention, the term “terminal hydroxyl group” is to be understood as meaning in particular a terminal hemiacetal functionality which is formed as a structural feature by the polymerization of formaldehyde. For example, the starter compounds may be oligomers and polymers of formaldehyde of general formula HO—(CH₂O)ₙ—H, wherein n is a natural number ≥2 and wherein polymeric formaldehyde typically has n>8 repeating units.

Polymeric formaldehyde suitable for the process according to the invention generally has molar masses of 62 to 30 000 g/mol, preferably of 62 to 12 000 g/mol, particularly preferably of 242 to 6000 g/mol and very particularly preferably of 242 to 3000 g/mol, and comprises from 2 to 1000, preferably from 2 to 400, particularly preferably from 8 to 200 and very particularly preferably from 8 to 100 oxymethylene repeating units. The polymeric formaldehyde employed in the process according to the invention typically has a functionality (F) of 1 to 3, but in certain cases may also have higher functionality, i.e. have a functionality >3. The process according to the invention preferably employs open-chain polymeric formaldehyde having terminal hydroxyl groups and having a functionality of 1 to 10, preferably of 1 to 5, particularly preferably of 2 to 3. It is very particularly preferable when the process according to the invention employs linear polymeric formaldehyde having a functionality of 2 with 2 terminal hydroxyl groups. The functionality F corresponds to the number of OH end groups (hydroxyl groups m) per molecule.

Preparation of polymeric formaldehyde used for the process according to the invention may be carried out by known processes (cf., for example, M. Haubs et. al., 2012, Polyoxymethylenes, Ullmann's Encyclopedia of Industrial Chemistry; G. Reus et. al., 2012, Formaldehyde, ibid). The process according to the invention may in principle also employ the polymeric formaldehyde in the form of a copolymer, wherein comonomers incorporated in the polymer in addition to formaldehyde are, for example, 1,4-dioxane or 1,3-dioxolane. Further suitable formaldehyde copolymers for the process according to the invention are copolymers of formaldehyde and of trioxane with cyclic and/or linear formals, for example butanediol formal, epoxides or cyclic carbonates (cf., for example, EP 3 080 177 B1). It is likewise conceivable for higher homologous aldehydes, for example acetaldehyde, propionaldehyde, etc., to be incorporated into the formaldehyde polymer as comonomers. It is likewise conceivable for polymeric formaldehyde according to the invention in turn to be prepared from H-functional starter compounds; obtainable here in particular through the use of polyfunctional starter compounds polymeric formaldehyde having a hydroxyl end group functionality F>2 (cf., for example, WO 1981001712 A1, Bull. Chem. Soc. J., 1994, 67, 2560-2566, U.S. Pat. No. 3,436,375, JP 03263454, JP 2928823).

As is well known, formaldehyde requires only the presence of small traces of water to polymerize. In aqueous solution, therefore, depending on the concentration and temperature of the solution, a mixture of oligomers and polymers of different chain lengths forms, in equilibrium with molecular formaldehyde and formaldehyde hydrate. So-called paraformaldehyde here precipitates out of the solution as a white, poorly soluble solid and is generally a mixture of linear formaldehyde polymers with 8 to 100 oxymethylene repeating units.

One advantage of the process according to the invention is in particular that polymeric formaldehyde/so-called paraformaldehyde, which is an inexpensive product commercially available on a large tonnage scale and has an advantageous carbon footprint (1.4 CO₂e/kg), may be used directly as a starter compound without any need for additional preparatory steps. The process according to the invention therefore employs paraformaldehyde as the starter compound. It is in particular possible via the molecular weight and the end group functionality of the polymeric formaldehyde starter compound to introduce polyoxymethylene blocks of defined molar weight and functionality into the product.

The length of the polyoxymethylene block may here advantageously be controlled in simple fashion in the process according to the invention via the molecular weight of the employed formaldehyde starter compound. Preferably employed here are linear formaldehyde starter compounds of general formula HO—(CH₂O)ₙ—H, wherein n is an integer ≥2, preferably where n=2 to 1000, particularly preferably where n=2 to 400 and very particularly preferably where n=8 to 100, having two terminal hydroxyl groups. Especially also employable as starter compound are mixtures of polymeric formaldehyde compounds of formula HO—(CH₂O)ₙ—H having different values of n in each case. In an advantageous embodiment the employed mixtures of polymeric formaldehyde starter compounds of formula HO—(CH₂O)ₙ—H contain at least 1% by weight, preferably at least 5% by weight and particularly preferably at least 10% by weight of polymeric formaldehyde compounds where n≥20.

A polyoxymethylene block (POM) in the context of the invention refers to a polymeric structural unit —(CH₂—O—)ₓ, wherein x is an integer ≥2, containing at least one CH₂ group bonded to two oxygen atoms which is bonded via at least one of the oxygen atoms to further methylene groups or other polymeric structures. Polyoxymethylene blocks —(CH₂—O—)ₓ preferably contain an average of x≥2 to x≤1000, more preferably an average of x≥2 to x≤400 and especially preferably an average of x≥8 to x≤100 oxymethylene units. In the context of the invention a polyoxymethylene block is also to be understood as meaning blocks having small proportions of further repeating units of monomeric and/or oligomeric units distinct from the oxymethylene repeating units, wherein the proportion of these units is generally less than 25 mol %, preferably less than 10 mol %, preferably less than 5 mol %, based on the total amount of the monomer units present in the block. These repeating units of monomeric and/or oligomeric units distinct from the oxymethylene repeating units are according to common general knowledge in the art (cf. G. Reus et. al., 2012, Formaldehyde, Ullmann's Encyclopedia of Industrial Chemistry; 2012) free water or water that is bound in the polyoxymethylene block for example.

In a preferred embodiment the polyoxymethylene block contains no further proportions of further repeating units of monomeric and/or oligomeric units distinct from the oxymethylene repeating units.

### Solvent

In the process according to the invention the solvent contains no OH-reactive functional groups and does not itself react with OH-reactive compounds.

In one embodiment of the process according to the invention the solvent used in step i) is an aprotic solvent.

In one embodiment of the process according to the invention the aprotic solvent has a boiling temperature of not more than 80° C., preferably not more than 70° C. and particularly preferably not more than 60° C. at 1 bara.

In one embodiment of the process according to the invention the aprotic solvent is one or more compound(s) and is selected from the group consisting of n-pentane, n-hexane, n-heptane, petroleum ether, carbon disulfide, carbon dioxide, trichlorethylene, methylene chloride, carbon tetrachloride, chloroform, trichlorofluoromethane, tetrabromomethane, bromodichloromethane, fluorobenzene, 1,4-difluorobenzene, dichlorofluoromethane, difluorodichloromethane, chlorodifluoromethane, ethyl acetate, isopropyl acetate, methyl formate, ethyl formate, isopropyl formate, propyl formate, acetaldehyde dimethyl acetal, acetonitrile, methyl tert-butyl ether, tert-butyl ethyl ether, tert-amyl methyl ether, methyl propyl ether, sec-butyl methyl ether, butyl methyl ether, methyl n-propyl ether, 1-ethoxypropane, 1,3-dioxolane, 1,1-dimethoxyethane, diisopropyl ether, 2-methyl-THF, 2,2 dimethoxypropane, dimethyl ether, dimethoxymethane, ethyl methyl ether, diethyl ether, diethoxymethane, dimethoxyethane, tetrahydrofuran (THF), 1,4,7,10-tetraoxacyclododecane ([12]crown-4), acetone and methyl ethyl ketone, preferably n-pentane, n-hexane, n-heptane, petroleum ether, carbon disulfide, carbon dioxide, ethyl acetate, methyl formate, acetonitrile, methyl tert-butyl ether, 1-ethoxypropane, 1,3-dioxolane, acetaldehyde dimethyl acetal, diisopropyl ether, 2-methyl-THF, 2,2-dimethoxypropane, dimethyl ether, dimethoxymethane, ethyl methyl ether, diethyl ether, diethoxymethane, dimethoxyethane, tetrahydrofuran (THF), acetone and methyl ethyl ketone, particularly preferably n-pentane, n-hexane, petroleum ether, carbon disulfide, carbon dioxide, methyl formate, methyl tert-butyl ether, 1-ethoxypropane, dimethoxyethane, dimethyl ether, dimethoxymethane, ethyl methyl ether, diethyl ether, tetrahydrofuran (THF) and acetone and very particularly preferably n-pentane, n-hexane, petroleum ether, carbon disulfide, carbon dioxide, methyl formate, methyl tert-butyl ether, dimethoxyethane, dimethyl ether, dimethoxymethane, ethyl methyl ether, diethyl ether and acetone.

### OH-Reactive Compound

In the process according to the invention, the OH-reactive compound has at least m OH-reactive (functional) groups, preferably 2 or 3, particularly preferably 2.

In one embodiment of the process according to the invention the OH-reactive compound is a dicarboxylic acid, a tricarboxylic acid, a dicarboxylic acid chloride, a tricarboxylic acid chloride, a dicarboxylic acid azide, a tricarboxylic acid azide, a dicarboxylic acid anhydride, a tricarboxylic acid anhydride, an organic diazide, an organic triazide, a diepoxide, a triepoxide, a halomethyloxirane, for example 1-chloro-2,3-epoxypropane (epichlorohydrin) or 1-bromo-2,3-epoxypropane (epibromohydrin), a diaziridine, a triaziridine, a disilyl chloride, a trisilyl chloride, a disilane, a trisilane, an n-alkyldi(magnesium halide), an n-alkyltri(magnesium halide), a disulfonyl chloride, a trisulfonyl chloride, an organic di(chlorosulfite), an organic tri(chlorosulfite), an organic di(phosphorus dibromide), an organic tri(phosphorus dibromide), polythiocyanate and/or a polyisocyanate, preferably a polyisocyanate.

In a preferred embodiment of the process according to the invention the OH-reactive compound is a polyisocyanate and the reaction is performed at an NCO index of ≥100 to ≤5000 to afford an NCO-terminated prepolymer.

The NCO index is defined as the percentage molar ratio of the NCO groups of the polyisocyanate to the terminal hydroxyl groups of the polymeric formaldehyde.

In one embodiment of the process according to the invention the polyisocyanate is one or more compound(s) and is selected from the group consisting of 1,4-diisocyanatobutane, 1,5-diisocyanatopentane (PDI), 1,6-diisocyanatohexane (HDI), 2-methyl-1,5-diisocyanatopentane, 1,5-diisocyanato-2,2-dimethylpentane, 2,2,4- or 2,4,4-trimethyl-1,6-diisocyanatohexane, 1,10-diisocyanatodecane, 1,3- and 1,4-diisocyanatocyclohexane, 1,3- and 1,4-bis(isocyanatomethyl)cyclohexane, 1-isocyanato-3,3,5-trimethyl-5-isocyanatomethylcyclohexane (isophorone diisocyanate, IPDI), 4,4′-diisocyanatodicyclohexylmethane (H12MDI), 4-isocyanatomethyl-1,8-octane diisocyanate (triisocyanatononane, TIN), ω,ω′-diisocyanato-1,3-dimethylcyclohexane (H6XDI), 1-isocyanato-1-methyl-3-isocyanatomethylcyclohexane, 1-isocyanato-1-methyl-4-isocyanatomethylcyclohexane, bis(isocyanatomethyl)norbornane, 1,5-naphthalene diisocyanate, 1,3- and 1,4-bis(2-isocyanato-prop-2-yl)benzene (TMXDI), 2,4-diisocyanatotoluene (TDI), 2,6-diisocyanatotoluene (TDI), 2,4- and 2,6-diisocyanatotoluene (TDI) in particular the 2,4 and 2,6-isomers and industrial mixtures of the two isomers, 2,4′-diisocyanatodiphenylmethane (MDI), 4,4′-diisocyanatodiphenylmethane (MDI), 2,4′- and 4,4′-diisocyanatodiphenylmethane (MDI), 1,5-diisocyanatonaphthalene, 1,3-bis(isocyanatomethyl) benzene (XDI) and any desired mixtures of the recited compounds, and also polyfunctional isocyanates obtained by dimerization or trimerization or higher oligomerization of the recited isocyanates, containing isocyanurate rings, iminooxadiazinedione rings, uretdione rings, urethonimine rings, as well as polyfunctional isocyanates obtained through adduct formation of the recited isocyanates onto mixtures of different more than difunctional alcohols, such as TMP, TME or pentaerythritol, preferably 1,5-diisocyanatopentane (PDI), 6-diisocyanatohexane (HDI), 1-isocyanato-3,3,5-trimethyl-5-isocyanatomethylcyclohexane (isophorone diisocyanate, IPDI), 4′-diisocyanatodicyclohexylmethane (H12MDI), 2,4-diisocyanatotoluene (TDI), 2,6-diisocyanatotoluene (TDI), 2,4- and 2,6-diisocyanatotoluene (TDI), in particular the 2,4 and 2,6-isomers, and industrial mixtures of the two isomers, 2,4′-diisocyanatodiphenylmethane (MDI), 4,4′-diisocyanatodiphenylmethane (MDI), 2,4′- and 4,4′-diisocyanatodiphenylmethane (MDI), 1,3-bis(isocyanatomethyl)benzene (XDI), trimerization or higher oligomerization products thereof and/or adducts thereof.

In the process according to the invention step ii) comprises reacting the at least one terminal hydroxyl group of the formaldehyde with the at least two OH-reactive group, preferably two NCO groups, of the OH-reactive compound, preferably of a polyisocyanate. This reaction may be carried out in the presence of a catalyst or without catalyst addition, preferably without catalyst addition.

In one embodiment of the process according to the invention amine-based and/or metal-based catalysts may be used for preparing an NCO-terminated prepolymer by reaction of formaldehyde with a polyisocyanate.

In one embodiment of the process according to the invention the amine-based catalyst is one or more compound(s) and is selected from the group consisting of N,N,-dimethylethanolamine (DEMEA), N,N-dimethylcyclohexylamine (DMCHEA), triethylenediamine (DABCO), dimethylcyclohexylamine, bis(N,N-dimethylaminoethyl) ether (BDMAEE), pentamethyldiethylenetriamine (PMDETA), 2-(2-dimethylaminoethoxy)ethanol (DMAEE), dimorpholinodiethylether (DMDEE), N-methyl-N′-(2-dimethylaminoethyl)piperazine, diazabicycloundecene (DBU), DBU phenoxide, pentamethyldipropylenetriamine, bisdimethylaminoethyl ether and pentamethyldiethylentriamine.

In one embodiment of the process according to the invention the metal-based catalyst is one or more compound(s) and is selected from the group consisting of dibutyltin dilaurate (DBTDL), tin (II) 2-ethylhexanoate, methyltin mercaptide, phenylmercury propionate and lead (II) octanoate.

### Steps:

The process according to the invention comprises step i) of preparing a formaldehyde solution (a) by adding a solvent to polymeric formaldehyde in a first container, followed by step ii) of withdrawing the formaldehyde solution prepared in step i) from the first container and transferring it to a second container containing OH-reactive compound to form a solution (b) and finally step iii) of distillatively recycling the solvent from the second container to the first container.

### Step i)

In one embodiment of the process according to the invention in step i) the solvent is added to the first container discontinuously or continuously, preferably continuously.

In one embodiment of the process according to the invention the formaldehyde solution (a) in step i) has temperatures in the first container of not more than 65° C., preferably not more than 55° C. and particularly preferably not more than 45° C. at a pressure of 0.1 bara to 100 bara, preferably from 1 bara to 20 bara.

### Step ii)

In one embodiment of the process according to the invention the formaldehyde solution prepared in step ii) is withdrawn from the first container discontinuously or continuously, preferably continuously.

In the process according to the invention the solution (b) in step ii) has temperatures in the second container of not more than 80° C., preferably not more than 70° C. and particularly preferably not more than 60° C., thus significantly reducing cleavage of the employed formaldehyde starter compounds into smaller polymers, oligomers and monomers and the formation of byproducts and decomposition products.

Furthermore, the temperature of the formaldehyde solution (a) in the first container in step i) is not more than the temperature of the solution (b) in the second container.

This solution (b) comprises the solvent, the OH-reactive compound and polymeric formaldehyde as well as reaction products from the OH-reactive compound and the and polymeric formaldehyde compound. For example ester-containing prepolymers are obtained by reaction of the hydroxyl-containing polymeric formaldehyde with carboxyl or anhydride groups of the OH-reactive compound. In a preferred embodiment urethane-containing, NCO-terminated prepolymers are obtained by reaction of the hydroxyl-containing polymeric formaldehyde with isocyanate groups (NCO) of the polyisocyanate.

The temperatures of the formaldehyde solution (a) or of the solution (b) resulting in the first or second container may be determined with various suitable temperature measuring instruments and hence may also be used to control the heating of the first or second container or are a consequence of the boiling temperatures of the employed solvents under the reaction conditions or the temperature of the solvent distillatively recycled in step iii).

In a preferred embodiment the solution (b) in step ii) has temperatures in the second container of not more than 80° C., preferably not more than 70° C. and particularly preferably not more than 60° C. at a pressure of 0.1 bara to 100 bara, preferably from 1 bara to 20 bara.

In one embodiment of the process according to the invention formaldehyde solution (a) passes through a filter during the transferring from the first container to the second container in step ii), wherein this step may likewise be carried out continuously or discontinuously.

Step iii)

In one embodiment of the process according to the invention the solvent is recycled from the second container to the first container in step iii) discontinuously or continuously, preferably continuously, thus reducing solvent requirements.

In the process according to the invention a continuous operating mode of the steps i), ii) and iii) and of the supplying of the reactants, withdrawing of the products, transferring and/or recycling is to be understood as meaning a volume flow of >0 mL/min, wherein the volume flow may be constant or varies during. By contrast, a discontinuous operating mode is to be understood as also meaning volume flows of 0 mL/min. One embodiment for the discontinuous operating mode comprises stepwise performance of the steps i), ii) and ii) and of the supplying of the reactants, withdrawing of the products, transferring and/or recycling. In one embodiment of the process according to the invention OH-reactive compound unreacted in the second container, preferably polyisocyanate, may be removed from the solution (b) to afford the prepolymer. This removal is preferably performed by distillation.

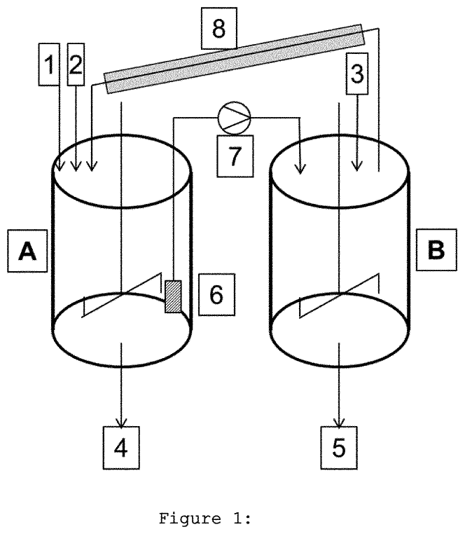

FIG. 1 shows an example of an industrial embodiment of the process according to the invention comprising the steps of
i) a first container (A) for preparing a formaldehyde solution (a) by continuously or discontinuously adding a solvent (1) to polymeric formaldehyde (2),
ii) continuously or discontinuously withdrawing the prepared formaldehyde solution (a) from the first container and transferring it (7), optionally using filtration 6), to a second container (B) containing OH-reactive compound optionally catalyst (3) to form a solution (b),
iii) and continuously or discontinuously distillatively recycling the solvent (8) from the second container (B) to the first container (A).

The withdrawing of the product mixture (5) comprising the prepolymer comprising polyoxymethylene block and optionally the unreacted OH-reactive compound is carried out with and without solvent. The withdrawing of the formaldehyde solution (a), polymeric formaldehyde and/or solvent (4) from the first container (A) as well as the withdrawing of the product mixture (5) with and without solvent from the second container (B) may be carried out discontinuously and continuously. The adding of solvent (1), formaldehyde (2) to the first container (A) as well as the adding of OH-reactive compound and the catalyst (3) may also be carried out discontinuously and continuously.

Furthermore, containers A and B are independently temperature controlled. The pressure of the overall system may also be adjusted/controlled. Mixing may be effected by power input, for example via mechanical stirring means. Containers A and B may be any desired process engineering apparatuses and are not limited to stirred tanks.

In one embodiment of the process according to the invention it is also possible to add to the preparation of an NCO-terminated prepolymer by reaction of formaldehyde with a polyisocyanate stabilizers such as for example benzoyl chloride, phthalic acid dichloride, chloropropionic acid, trifluoroacetic acid, trifluoroacetic anhydride, trifluoromethanesulfonic acid, dimethylcarbamoyl chloride, hydrogen chloride, hydrochloric acid, sulfuric acid, thionyl chloride, sulfonic acid derivatives, phosphorus trichloride, phosphorus pentachloride, orthophosphoric acid, diphosphoric acid, polyphosphoric acid (PPA), polymetaphosphoric acid, phosphorus pentoxide and (partial) esters of the abovementioned phosphoric acid compounds, for example dibutyl phosphate, in amounts of 0.5 ppm to 2% by weight for example.

The present invention further provides polyoxymethylene block copolymers, preferably an NCO-terminated prepolymer, obtainable by the process according to the invention having a number-average number of polyoxymethylene repeating units of 2 to 50, preferably 4 to 30 and particularly preferably from 8 to 20, wherein the number of polyoxymethylene repeating units was determined by proton resonance spectroscopy.

In one embodiment the prepolymer comprising polyoxymethylene block is an NCO-terminated prepolymer having a content of reactive isocyanate groups of ≥4% by weight to ≤25% by weight based on the mass of the prepolymer comprising polyoxymethylene block of the isocyanate groups in the prepolymer comprising polyoxymethylene block, wherein the content of reactive isocyanate groups was determined by NMR spectroscopy by derivatization with methanol.

### Mixture

The present invention further provides mixtures comprising the polyoxymethylene block copolymers according to the invention, preferably the NCO-terminated prepolymers, and the OH-reactive compound according to the invention, preferably polyisocyanates.

In one embodiment the mixture according to the invention has a content of reactive isocyanate groups of ≥4% by weight to ≤50% by weight based on the total proportion of the isocyanate groups, wherein the content of reactive isocyanate groups was determined by NMR spectroscopy by derivatization with methanol.

The polyoxymethylene block copolymers, preferably an NCO-terminated prepolymer, obtainable by the process according to the invention are readily processable. In the case of NCO-terminated prepolymers according to the invention or the mixtures according to the invention comprising polyisocyanates and NCO-terminated prepolymers according to the invention, said prepolymers may be reacted with the at least two NCO-reactive groups of NCO-reactive compounds. Using hydroxyl groups as NCO-reactive groups affords polyurethanes or polyisocyanurates, in particular polyurethane thermoplastics, polyurethane coatings, fibers, elastomers, adhesives and in particular also polyurethane foams including flexible foams (for example flexible slabstock polyurethane foams and flexible molded polyurethane foams) and rigid foams.

Polyurethane applications preferably employ polyoxymethylene block copolymers having a functionality of at least 2. In addition, the polyoxymethylene block copolymers obtainable by the process according to the invention may be used in applications such as washing and cleaning composition formulations, adhesives, paints, coatings, functional fluids, drilling fluids, fuel additives, ionic and nonionic surfactants, lubricants, process chemicals for papermaking or textile manufacture, or cosmetic/medicinal formulations. The person skilled in the art is aware that, depending on the respective field of use, the polymers to be used have to fulfill certain physical properties, for example molecular weight, viscosity, polydispersity, functionality and/or hydroxyl number (number of terminal hydroxyl groups per molecule).

The invention therefore likewise relates to the use of prepolymer according to the invention comprising polyoxymethylene block for preparing polyurethane polymers. In one embodiment of this use the polyurethane polymers are flexible polyurethane foams or rigid polyurethane foams. In a further embodiment of this use the polyurethane polymers are thermoplastic polyurethane polymers.

The invention therefore likewise provides a polyurethane polymer obtainable by reaction of an an NCO-reactive compound containing at least two terminal hydroxyl groups as NCO-reactive groups with at least one prepolymer according to the invention comprising polyoxymethylene block, preferably NCO-terminated prepolymer.

The invention likewise provides a flexible polyurethane foam or a rigid polyurethane foam obtainable by reaction of an an NCO-reactive compound containing at least two terminal hydroxyl groups as NCO-reactive groups with at least one prepolymer according to the invention comprising polyoxymethylene block, preferably NCO-terminated prepolymer.

Also included according to the invention is the use of prepolymer comprising polyoxymethylene block according to the present invention for preparing polyurethanes, washing and cleaning composition formulations, drilling fluids, fuel additives, ionic and nonionic surfactants, lubricants, process chemicals for papermaking or textile production or cosmetic formulations.

The invention further provides an industrial chemical process for preparing a product of defined composition comprising the steps of:

i) preparing a reactant solution (1) by adding a solvent (1) to a reactant (1) having a solubility of <1 g/L and having a melting point not less than its decomposition point in a first container,
ii) withdrawing the reactant solution (1) prepared in step i) from the first container and transferring it to a second container containing a reactant (1)-reactive compound to form a solution (2) containing the product,
iii) distillatively recycling the solvent (1) from the second container to the first container,
wherein the solution (2) containing the product in step ii) has a temperature in the second container of not more than 150° C., preferably not more than 130° C. and particularly preferably not more than 110° C.;
wherein the temperature in the first container in step i) is not more than the temperature in the second container;
and wherein the solvent (1) does not react with the reactant (1), the reactant (1)-reactive compound and the product.

It is preferable when the thermal stability of the product is higher than that of the reactant (1).

Here, the reactant (1) according to the invention is one or more compounds and selected from the class of organic compounds or organometallic compounds.

The reactant (1) according to the invention preferably has a thermal stability above the boiling temperature of the solvent (1) under process conditions.

In one embodiment of the process according to the invention in step i) the solvent (1) is added to the first container discontinuously or continuously, preferably continuously.

In one embodiment of the process according to the invention the reactant solution (1) prepared prepared in step ii) is withdrawn from the first container discontinuously or continuously, preferably continuously.

In one embodiment of the process according to the invention in step iii) the solvent (1) is recycled from the second container to the first container discontinuously or continuously, preferably continuously, thus reducing solvent requirements.

FIG. 1 shows an example of an industrial embodiment of the industrial chemical process according to the invention for preparing a product of defined composition comprising the steps of
i) a first container (A) for preparing a reactant solution by continuously or discontinuously adding a solvent (1) to a reactant which is added to container (A) via opening (1), has a solubility of <1 g/L and a melting point not less than its decomposition point in a first container,
ii) continuously or discontinuously withdrawing the reactant solution prepared in step i) from the first container (A) and transferring it (7), optionally using filtration (6), to a second container (B) containing a reactant-reactive compound (3) optionally containing a catalyst to form a solution containing the product,
iii) and continuously or discontinuously distillatively recycling the solvent (8) from the second container (B) to the first container (A).

The withdrawing of the product mixture (5) comprising the product and optionally the unreacted, reactant-reactive compound is carried out with and without solvent. The withdrawing of the reactant solution, the reactant and/or solvent (4) from the first container (A) as well as the withdrawing of the product mixture (5) with and without solvent from the second container (B) may be carried out discontinuously and continuously. The adding of solvent (1), reactant (2) to the first container (A) as well as the adding of reactant-reactive compound (3) and the optionally a catalyst may also be carried out discontinuously and continuously.

In a first embodiment the invention relates to a process for preparing a prepolymer comprising a polyoxymethylene block, wherein the process comprises the steps of:

i) preparing a formaldehyde solution (a) by adding a solvent to polymeric formaldehyde in a first container;
ii) withdrawing the formaldehyde solution prepared in step i) from the first container and transferring it to a second container containing OH-reactive compound to form a solution (b) containing the prepolymer;
iii) distillatively recycling the solvent from the second container to the first container;
wherein the polymeric formaldehyde has m terminal hydroxyl groups;
wherein m is a natural number of two or more,
wherein the OH-reactive compound has m or more terminal OH-reactive groups;
wherein the solvent contains no OH-reactive functional groups and does not itself react with OH-reactive compounds;
wherein the solution (b) in step ii) has a temperature in the second container of not more than 80° C., preferably not more than 70° C. and particularly preferably not more than 60° C.;
and wherein the temperature of the formaldehyde solution (a) in the first container in step i) is not more than the temperature of the solution (b) in the second container.

In a second embodiment the invention relates to a process according to the first embodiment, wherein in step i) the solvent is added to the first container discontinuously or continuously.

In a third embodiment the invention relates to a process according to the first or second embodiment, wherein the formaldehyde solution prepared in step ii) is withdrawn from the first container discontinuously or continuously.

In a fourth embodiment the invention relates to a process according to any of the first to third embodiments, wherein in step iii) the solvent is recycled from the second container to the first container discontinuously or continuously.

In a fifth embodiment the invention relates to a process according to any of the first to fourth embodiments, wherein the solvent used in step i) is an aprotic solvent.

In a sixth embodiment the invention relates to a process according to the fifth embodiment, wherein the aprotic solvent has a boiling temperature of not more than 80° C., preferably not more than 70° C. and particularly preferably not more than 60° C. at 1 bara.

In a seventh embodiment the invention relates to a process according to the fifth or sixth embodiment, wherein the aprotic solvent is one or more compound(s) and is selected from the group consisting of n-pentane, n-hexane, n-heptane, petroleum ether, carbon disulfide, carbon dioxide, trichlorethylene, methylene chloride, carbon tetrachloride, chloroform, trichlorofluoromethane, tetrabromomethane, bromodichloromethane, fluorobenzene, 1,4-difluorobenzene, dichlorofluoromethane, difluorodichloromethane, chlorodifluoromethane, ethyl acetate, isopropyl acetate, methyl formate, ethyl formate, isopropyl formate, propyl formate, acetaldehyde dimethyl acetal, acetonitrile, methyl tert-butyl ether, tert-butyl ethyl ether, tert-amyl methyl ether, methyl propyl ether, sec-butyl methyl ether, butyl methyl ether, methyl n-propyl ether, 1-ethoxypropane, 1,3-dioxolane, 1,1-dimethoxyethane, diisopropyl ether, 2-methyl-THF, 2,2 dimethoxypropane, dimethyl ether, dimethoxymethane, ethyl methyl ether, diethyl ether, diethoxymethane, dimethoxyethane, tetrahydrofuran (THF), 1,4,7,10-tetraoxacyclododecane ([12]crown-4), acetone and methyl ethyl ketone, preferably n-pentane, n-hexane, n-heptane, petroleum ether, carbon disulfide, carbon dioxide, ethyl acetate, methyl formate, acetonitrile, methyl tert-butyl ether, 1-ethoxypropane, 1,3-dioxolane, acetaldehyde dimethyl acetal, diisopropyl ether, 2-methyl-THF, 2,2 dimethoxypropane, dimethyl ether, dimethoxymethane, ethyl methyl ether, diethyl ether, diethoxymethane, dimethoxyethane, tetrahydrofuran (THF), acetone and methyl ethyl ketone, particularly preferably n-pentane, n-hexane, petroleum ether, carbon disulfide, carbon dioxide, methyl formate, methyl tert-butyl ether, 1-ethoxypropane, dimethoxyethane, dimethyl ether, dimethoxymethane, ethyl methyl ether, diethyl ether, tetrahydrofuran (THF) and acetone and very particularly preferably n-pentane, n-hexane, petroleum ether, carbon disulfide, carbon dioxide, methyl formate, methyl tert-butyl ether, dimethoxyethane, dimethyl ether, dimethoxymethane, ethyl methyl ether, diethyl ether and acetone.

In an eighth embodiment the invention relates to a process according to any of the first to seventh embodiments, wherein the OH-reactive compound is a dicarboxylic acid, a tricarboxylic acid, a dicarboxylic acid chloride, a tricarboxylic acid chloride, a dicarboxylic acid azide, a tricarboxylic acid azide, a dicarboxylic acid anhydride, a tricarboxylic acid anhydride, an organic diazide, an organic triazide, a diepoxide, a triepoxide, a halomethyloxirane, for example 1-chloro-2,3-epoxypropane (epichlorohydrin) or 1-bromo-2,3-epoxypropane (epibromohydrin), a diaziridine, a triaziridine, a disilyl chloride, a trisilyl chloride, a disilane, a trisilane, an n-alkyldi(magnesium halide), an n-alkyltri(magnesium halide), a disulfonyl chloride, a trisulfonyl chloride, an organic di(chlorosulfite), an organic tri(chlorosulfite), an organic di(phosphorus dibromide), an organic tri(phosphorus dibromide), polythiocyanate and/or a polyisocyanate, preferably a polyisocyanate.

In a ninth embodiment the invention relates to a process according to the eighth embodiment, wherein the OH-reactive compound is a polyisocyanate and the reaction is performed at an NCO index of ≥100 to ≤5000 to afford an NCO-terminated prepolymer.

In a tenth embodiment the invention relates to a process according to the ninth embodiment, wherein the polyisocyanate is one or more compound(s) and is selected from the group consisting of 1,4-diisocyanatobutane, 1,5-diisocyanatopentane (PDI), 1,6-diisocyanatohexane (HDI), 2-methyl-1,5-diisocyanatopentane, 1,5-diisocyanato-2,2-dimethylpentane, 2,2,4- or 2,4,4-trimethyl-1,6-diisocyanatohexane, 1,10-diisocyanatodecane, 1,3- and 1,4-diisocyanatocyclohexane, 1,3- and 1,4-bis(isocyanatomethyl)cyclohexane, 1-isocyanato-3,3,5-trimethyl-5-isocyanatomethylcyclohexane (isophorone diisocyanate, IPDI), 4,4′-diisocyanatodicyclohexylmethane (H12MDI), 4-isocyanatomethyl-1,8-octane diisocyanate (triisocyanatononane, TIN), ω,ω′-diisocyanato-1,3-dimethylcyclohexane (H6XDI), 1-isocyanato-1-methyl-3-isocyanatomethylcyclohexane, 1-isocyanato-1-methyl-4-isocyanatomethylcyclohexane, bis(isocyanatomethyl)norbornane, 1,5-naphthalene diisocyanate, 1,3- and 1,4-bis(2-isocyanato-prop-2-yl)benzene (TMXDI), 2,4-diisocyanatotoluene (TDI), 2,6-diisocyanatotoluene (TDI), 2,4- and 2,6-diisocyanatotoluene (TDI) in particular the 2,4 and 2,6-isomers and industrial mixtures of the two isomers, 2,4′-diisocyanatodiphenylmethane (MDI), 4,4′-Diisocyanatodiphenylmethane (MDI), 2,4′- and 4,4′-diisocyanatodiphenylmethane (MDI), 1,5-diisocyanatonaphthalene, 1,3-bis(isocyanatomethyl) benzene (XDI) and any desired mixtures of the recited compounds, and also polyfunctional isocyanates obtained by dimerization or trimerization or higher oligomerization of the recited isocyanates, containing isocyanurate rings, iminooxadiazinedione rings, uretdione rings, urethonimine rings, as well as polyfunctional isocyanates obtained through adduct formation of the recited isocyanates onto mixtures of different more than difunctional alcohols, such as TMP, TME or pentaerythritol, preferably 1,5-diisocyanatopentane (PDI), 6-diisocyanatohexane (HDI), 1-isocyanato-3,3,5-trimethyl-5-isocyanatomethylcyclohexane (isophorone diisocyanate, IPDI), 4′-diisocyanatodicyclohexylmethane (H12MDI), 2,4-diisocyanatotoluene (TDI), 2,6-diisocyanatotoluene (TDI), 2,4- and 2,6-diisocyanatotoluene (TDI), in particular the 2,4 and 2,6-isomers, and industrial mixtures of the two isomers, 2,4′-diisocyanatodiphenylmethane (MDI), 4,4′-diisocyanatodiphenylmethane (MDI), 2,4′- and 4,4′-diisocyanatodiphenylmethane (MDI), 1,3-bis(isocyanatomethyl)benzene (XDI), trimerization or higher oligomerization products thereof and/or adducts thereof.

In an eleventh embodiment the invention relates to a prepolymer comprising polyoxymethylene block prepared by any of the preceding claims, preferably an NCO-terminated prepolymer obtainable according to the ninth or tenth embodiment, having a number-average number of polyoxymethylene repeating units of 2 to 50, preferably 4 to 30 and particularly preferably from 8 to 20, wherein the number of polyoxymethylene repeating units was determined by proton resonance spectroscopy.

In a twelfth embodiment the invention relates to a prepolymer comprising polyoxymethylene block of the eleventh embodiment, wherein the prepolymer comprising polyoxymethylene block is an NCO-terminated prepolymer having a content of reactive isocyanate groups of ≥4% by weight to ≤25% by weight based on the mass of the prepolymer comprising polyoxymethylene block of the isocyanate groups in the prepolymer comprising polyoxymethylene block, wherein the content of reactive isocyanate groups was determined by NMR spectroscopy by derivatization with methanol.

In a thirteenth embodiment the invention relates to a mixture comprising a prepolymer comprising polyoxymethylene blocks according to the eleventh or twelfth embodiment and an OH-reactive compound, preferably polyisocyanate according to any of the ninth to eleventh embodiments.

In a fourteenth embodiment the invention relates to a mixture according to the thirteenth embodiment, wherein the mixture has a content of reactive isocyanate groups of ≥4% by weight to ≤50% by weight based on the total proportion of the isocyanate groups, wherein the content of reactive isocyanate groups was determined by NMR spectroscopy by derivatization with methanol.

### EXAMPLES

### Employed Compounds:

pFA-1: Paraformaldehyde (trade name: Granuform® 91 (formaldehyde content according to manufacturer 89.5-92.5%), INEOS Paraform GmbH & Co. KG).
pFA-2: Paraformaldehyde (Granuform® M, (formaldehyde content according to manufacturer in each case 94.5-96.5%), INEOS Paraform GmbH & Co. KG).

Dimethoxymethane, DMM (99.9%, Sigma-Aldrich Chemie GmbH, dried over CaH₂, distilled and stored over 4 A molecular sieve)

HDI (Desmodur H, >99%, Covestro Deutschland AG, no pretreatment)

TDI (Desmodur T 100, toluene 2,4-diisocyanate, >99%, Covestro Deutschland AG, no pretreatment)

IPDI (Isophorone Diisocyanate, 98%, Sigma-Aldrich Chemie GmbH, no pretreatment)

n-pentane (>99%, Sigma-Aldrich Chemie GmbH, distilled and stored over 3 A molecular sieve)

Methanol (99.8%, Sigma-Aldrich Chemie GmbH, dried over 3 A molecular sieve)

CDCL₃ (99.80% D, Euriso-Top GmbH, dried over 4 A molecular sieve)

DMSO-d6 (99.80% D, Euriso-Top GmbH, dried over 4 A molecular sieve)

CH₂Cl₂ (>99.8%, Sigma-Aldrich Chemie GmbH, dried over 4 A molecular sieve)

### Method Description:

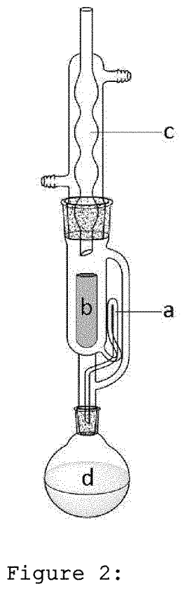

Reactive soxhlet extraction: Continuous preparation of the NCO-terminated prepolymer comprising a polyoxymethylene block may employ a laboratory apparatus according to FIG. 2 consisting of a flask (second container (cf. FIG. 2 (c))) containing the solvent and the OH-reactive compound, an extraction attachment (Soxhlet extractor, first container, cf. FIG. 2 (a)) and a reflux condenser. Arranged in the Soxhlet extractor is a solid extraction thimble made of cellulose which contains the polymeric formaldehyde compound as the solid to be extracted. The solvent in the flask is partially evaporated; the condensate continuously fills the extractor and extraction thimble and soluble constituents accumulate in the solvent. As soon as the solution in the Soxhlet extractor reaches a level specified by a laterally arranged siphon, the extractor empties all at once into the round bottom flask (second container) therebelow. There the solvent is distilled off from the soluble constituents, ascends through the Soxhlet extractor, condenses in the reflux condenser (cf. FIG. 2 (c)) and runs into the extractor/the extraction thimble (cf. FIG. 2 (b)). In this way the solvent is recycled over a longer period of time, a small amount of soluble constituents of the solid always being transferred to the lower flask (cf. E. Fanghanel: Organikum, 22nd Ed., WILEY-VHC Verlag GmbH, Weinheim, 2004, page 540. In the lower flask the extracted solid will be reacted with a reaction partner (for example OH-reactive compound), i.e. a special form of combination of extraction and reaction will be carried out. The reaction of the extracted substance with the OH-reactive compounds is carried out with and without a catalyst. A possible industrial embodiment of this special form of reactive Soxhlet extraction is shown in FIG. 2.

¹H NMR spectroscopy: The measurements were performed using a Bruker AV400 (400 MHz) instrument; the chemical shifts were calibrated relative to the residual proton signal (CDCl₃: δ ¹H=7.26 ppm, DMSO-d6: δ ¹H=2.50 ppm); the multiplicity of the signals was indicated as follows: s=singlet, m=multiplet, b=broadened signal, cr=complex region (superimposed multiplets).

¹³C NMR spectroscopy: The measurements were performed using a Bruker AV400 (100 MHz) instrument; the chemical shifts were calibrated relative to the solvent signal (CDCl₃: δ ¹³C=77.16 ppm, DMSO-d6: δ ¹³C=39.52 ppm);

Polyoxymethylene group content: The content of polyoxymethylene groups n in the NCO prepolymer was determined using ¹H-NMR spectroscopy. The relative contents of the individual groups were determined by integration of the characteristic proton signals. The characteristic signals of the polyoxymethylene groups directly adjacent to the carbamate unit (δ ¹H 5.34, 4H, OCH₂*) are shifted downfield compared to those of the internal polyoxymethylene groups (δ ¹H 4.83, n H, OCH₂). Once the integral of the OCH₂* signal has been normalized to four the content of polyoxymethylene groups n in the NCO prepolymer may be calculated via the following formula:

$$n - = \frac{Integral ( {OCH}_{2} ) + 4}{2}$$

Characteristic proton signals of the polyoxymethylene groups directly adjacent to the carbamate unit correlate with the ¹³C-NMR signals of the carbamate C═O units:

¹H/¹³C HMBC-NMR (400/100 MHz, DMSO-d6, 298 K; selected cross-resonance) δ ¹H/δ ¹H/¹³C [ppm]: 5.34/153.07 (4H, OCH₂*/C═O).

NCO content determination by isocyanate derivatization with MeOH: To determine the NCO contents the reactive NCO groups of the prepolymers were initially derivatized with excess methanol to afford the corresponding carbamate species. The product mixture was largely freed of solvent, admixed with an excess of dry methanol and stirred at 60° C. for 2 h. After thorough removal of the excess methanol under high vacuum the NCO content was determined by NMR spectroscopy by integration of the characteristic proton signals of the terminal methoxy groups (—OMe). To this end 40 mg of the prepolymer were dissolved in 0.5 mL of DMSO-d6 and admixed with a defined amount of a dry dichloromethane standard (integral=1). A ¹H-NMR spectrum of this mixture was recorded with 64 scans, the ratios of the corresponding fragments (—OMe [δ ¹H 3.80-3.45 ppm], CH₂Cl₂ [δ¹H 5.76 ppm]) determined by integration and the NCO content calculated via the following formula:

$$NCO content [ \% ] = \frac{( \frac{Integral ( OMe )}{1.5 \times Integral ( DCM )} ) \times m mol DCM}{mg sample} \times {MW}_{NCO group} \times 100$$

### Example 1: Reaction of pFA-2 (INEOS, Granuform® M) with DMM and Toluene 2,4-Diisocyanate (TDI) by Reactive Soxhlet Extraction

Paraformaldehyde pFA-2 (Granuform® M, 10.5 g) was initially charged in the extraction thimble of a Soxhlet extractor. By Soxhlet extraction with dimethoxymethane (DMM for short) as solvent (200 ml) polymeric formaldehyde was extracted under reflux (60° C. oil bath temperature) and reacted with an excess of TDI (12.1 g) in the flask therebelow. After an extraction time of 66 hours the solvent was removed under reduced pressure, the residue was washed with dried n-pentane and the reaction product was obtained as a colorless solid.

According to the ¹H NMR spectrum the obtained NCO-terminated prepolymer has on average 12 oxymethylene units and the molecular weight calculated therefrom (MW_{calc}) is thus 726.7 g/mol. The presence of urethane groups was determined via characteristic cross-resonances in the ¹H/¹³C HMBC NMR spectrum. Characteristic bands in the IR spectrum show the presence of NCO and carbamate functionalities. The NCO content was determined by derivatization of the free isocyanate groups with MeOH and subsequent integration of characteristic signals in the 41 NMR spectrum.

### Characterization:

¹H NMR (600 MHz, DMSO-d6, 298 K) δ [ppm]: 7.24 (m br, 6H, H_{Ar}), 5.34 (m, 4H, OCH₂), 4.83 (m, 20H, OCH₂′), 2.34-1.86 (s, 6H, Me).

¹H/¹³C HMBC NMR (600/150 MHz, DMSO-d6, 298 K; selected cross-resonance) δ¹H/δ ¹³C [ppm]: 5.34/153.07 (OCH₂/CO).

IR: v (cm⁻¹)=2251 (s, NCO), 1702 (s, ^{NH}CO).

NCO content: 18% by weight.

### Example 2: Reaction of pFA-1 (INEOS, Granuform® 91) with DMM and Toluene 2,4-Diisocyanate (TDI) by Reactive Soxhlet Extraction to Afford the NCO-Terminated Prepolymer

The reaction, workup and analysis were performed analogously to example 1 with the exception that pFA-1, Granuform 91® (10.5 g) was employed as the starting material.

According to the ¹H NMR spectrum the obtained NCO prepolymer has on average 8 oxymethylene units and the molecular weight calculated therefrom (MW_{calc.}) is thus 606.6 g/mol. The presence of urethane groups was determined via characteristic cross-resonances in the ¹H/¹³C HMBC NMR spectrum. Characteristic bands in the IR spectrum show the presence of NCO and carbamate functionalities. The NCO content was determined by derivatization of the free isocyanate groups with MeOH and subsequent integration of characteristic signals in the ¹H NMR spectrum.

### Characterization:

¹H NMR (400 MHz, DMSO-d6, 296 K) δ [ppm]: 7.78-6.79 (m br, 6H, H_{Ar}), 5.35 (m, 4H, OCH₂), 5.01-4.72 (m, 20H, OCH₂′), 2.34-1.86 (s, 6H, Me).

¹H/¹³C HMBC NMR (400/100 MHz, DMSO-d6, 298 K; selected cross-resonance) δ ¹H/δ ¹³C [ppm]: 5.35/152.4 (OCH₂/CO).

IR: v (cm⁻¹)=2251 (s, NCO), 1702 (s, ^{NH}CO).

NCO content: 21% by weight.

### Example 3 (Comparative): Reaction of pFA-2 (INEOS, Granuform® M) with Toluene 2,4-Diisocyanate (TDI) without Solvent Addition Under Reflux Conditions

pFA-2 (Granuform® M, 10.5 g) and TDI (12.1 g) were transferred to a Schlenk flask under argon and the resulting white suspension was stirred at 60° C. for 66 hours. This afforded a hard white solid which could no longer be stirred. The undefinable polymeric solid was mechanically comminuted, washed with hexane and dried under vacuum. The resulting residue was admixed with dry dichloromethane and filtered. The filtrate was then freed of solvent under reduced pressure. NMR spectroscopic analyses of the resulting white solid indicate a highly complex mixture which cannot be further characterized.

### Example 4 (comparative): Reaction of pFA-1 (INEOS, Granuform® 91) with DMM and Toluene 2,4-Diisocyanate (TDI) Under Reflux Conditions

pFA-1 (10.5 g), dimethoxymethane (200 mL) and TDI (12.5 g) were transferred to a Schlenk flask under argon. The resulting white suspension was stirred under reflux (60° C. oil bath temperature) for 66 hours. The solvent was then removed under reduced pressure and the residue was washed multiple times with dry n-pentane. The obtained residue is a complex mixture of various components which cannot be further characterized. NMR spectroscopic analyses suggest that the chosen experimental conditions result in formation of monomeric formaldehyde which reacts with TDI to afford undefined adducts.

### Example 5: Reaction of pFA-2 (INEOS, Granuform® M) with DMM and Toluene 2,4-Diisocyanate (TDI) by Reactive Soxhlet Extraction to Afford the Mixture of NCO-Terminated Prepolymer and TDI

The reaction was carried out analogously to Example 1 with the exception that a little less TDI (10.0 g) was used and the reaction product was not freed of excess TDI by washing after removing the solvent.

According to the ¹H NMR spectrum the obtained mixture of NCO-terminated prepolymer and unreacted TDI (NCO semi-prepolymer) has on average 9 oxymethylene units and the molecular weight calculated therefrom (MW_{calc}) is thus 636.6 g/mol. The presence of urethane groups was determined via characteristic cross-resonances in the ¹H/¹³C HMBC NMR spectrum. Characteristic bands in the IR spectrum show the presence of NCO and carbamate functionalities. The NCO content was determined by derivatization of the free isocyanate groups with MeOH and subsequent integration of characteristic signals in the ¹H NMR spectrum.

### Characterization:

¹H NMR (400 MHz, DMSO-d6, 296 K) δ [ppm]: 7.78-6.79 (m br, 6H, H_{Ar}), 5.35 (m, 4H, OCH₂), 5.01-4.72 (m, 16H, OCH₂′), 2.34-1.86 (s, 6H, Me) [NCO prepolymer].

7.50 (s, 1H, H_{Ar}), 7.17 (dm, ³J_{HH}=8.3 Hz, 1H, H_{Ar}), 7.06 (d ³J_{HH}=8.3 Hz, 1H, H_{Ar}), 2.12 (s, 3H, CH₃) [TDI].

[GHG-260-FOR]

¹H/¹³C HMBC NMR (400/100 MHz, DMSO-d6, 298 K; selected cross-resonance) δ ¹H/δ ¹³C [ppm]: 5.35/152.3 (OCH₂/CO).

IR: v (cm⁻¹)=2251 (s, NCO), 1702 (s, ^{NH}CO).

NCO content: 32% by weight.

### Example 6: Reaction of pFA-2 (INEOS, Granuform® M) with DMM and Hexamethylene Diisocyanate (HDI) by Reactive Soxhlet Extraction to Afford the NCO-Terminated Prepolymer

The reaction, workup and analysis were performed analogously to example 1 with the exception that HDI (9.64 g) was employed instead of TDI.

According to the 1H NMR spectrum the NCO prepolymer has on average 8 oxymethylene units and the molecular weight calculated therefrom (MWcalc.) is thus 606.6 g/mol. The presence of urethane groups on oxymethylene units was determined via characteristic cross-resonances in the 1H/13C HMBC NMR spectrum. Characteristic bands in the IR spectrum show the presence of NCO and carbamate functionalities. The NCO content was determined by derivatization of the free isocyanate groups with MeOH and subsequent integration of characteristic signals in the 1H NMR spectrum.

Characterization:

¹H NMR (400 MHz, DMSO-d6, 296 K) δ [ppm]: 7.34 (m, 2H, NH), 5.19 (m, 4H, OCH₂), 4.78 (m, 12H, OCH₂′), 3.33 (m, 4H, ^{NCO}CH₂), 3.13 (m, 4H, ^{NH}CH₂), 1.54 (m, 4H, CH₂), 1.35 (m, 12H, CH₂′).

¹H/¹³C HMBC NMR (600/150 MHz, DMSO-d6, 298 K; selected cross-resonance) δ ¹H/δ ¹³C [ppm]: 5.35/155.1 (OCH₂/CO).

IR: v (cm⁻¹)=2251 (s, NCO), 1702 (s, ^{NH}CO).

NCO content: 16% by weight.

### Example 7: Reaction of pFA-1 (INEOS, Granuform® M) with DMM and Isophorone Diisocyanate (IPDI) by Reactive Soxhlet Extraction to Afford the NCO-Terminated Prepolymer

Paraformaldehyde pFA-1 (Granuform® M, 15 g) was initially charged in the extraction thimble of a Soxhlet extractor. By Soxhlet extraction with dimethoxymethane as solvent (200 ml) soluble pFA oligomers were extracted under reflux (52° C. oil bath temperature) and reacted with an excess of IPDI (4.72 g) in the flask therebelow. After an extraction time of 138 hours the solvent was removed under reduced pressure, the residue was washed with dried n-pentane and the reaction product was obtained as a colorless solid.

According to the ¹H NMR spectrum the NCO prepolymer has on average 10 oxymethylene units and the molecular weight calculated therefrom (MW_{calc.}) is thus 762.6 g/mol. The presence of urethane groups on oxymethylene units was determined via characteristic cross-resonances in the ¹H/¹³C HMBC NMR spectrum. Characteristic bands in the IR spectrum show the presence of NCO and carbamate functionalities. The NCO content was determined by derivatization of the free isocyanate groups with MeOH and subsequent integration of characteristic signals in the ¹H NMR spectrum.

Characterization:

¹H NMR (400 MHz, DMSO-d6, 298 K) δ [ppm]: 7.34 (m, 2H, NH), 5.24 (m, 4H, OCH₂), 4.80 (m, 17H, OCH₂′), 3.89-3.03 (cr, 6H, ^{N}CH & ^{N}CH₂), 1.88-1.10 (cr, 12H, CH₂), 1.07-0.75 (m, 18H, CH₃). ¹H/¹³C HMBC NMR (400/100 MHz, DMSO-d6, 299 K; selected cross-resonance) δ ¹H/δ ¹³C [ppm]: 5.24/153.4 (OCH₂/CO).

IR: v (cm⁻¹)=2251 (s, NCO), 1702 (s, ^{NH}CO).

NCO content: 17% by weight.

### Example 8 (Comparative): Reaction of pFA-1 (INEOS, Granuform® M) with Toluene Diisocyanate (TDI) According to Example 2 from U.S. Pat. No. 3,575,930 A1

Paraformaldehyde pFA-2 (Granuform® M, 10 g) was boiled in a flask with 90 g of dioxane for 2 minutes and filtered. The resulting solution was admixed with 20 mL of benzene and dried by azeotropic distillation. 16.7 g of TDI were then added and the reaction mixture was heated to 91° C. over 6 h. In contrast to example 2 from U.S. Pat. No. 3,575,930 A1 it was not possible to directly filter off any polymeric product from the reaction solution. Even after removal of the volatile constituents at 35° C. and 10 mbar no polymeric product or NCO prepolymer was obtained. The 41 NMR spectrum of this yellow residue showed only signals attributable to TDI. No build-up of polymers having NCO groups or NCO prepolymers was able to be observed.

### Characterization:

¹H NMR (400 MHz, DMSO-d6, 298 K) δ [ppm]: 7.27-7.20 (m, 2H, H_{Ar}), 7.06-7.04 (m, 1H, H_{Ar}), 2.26 (s, 3H, CH₃).

| | | | OH-reactive | Step | Step | | M_{W}(calc.) | NCO |
|---|---|---|---|---|---|---|---|---|
| Example | pFA | LM | compound | ii)^{a)} | iii)^{b)} | n^{c)} | [g/mol] | [% by wt.] |
| 1 | 2 | DMM | TDI | yes | yes | 12 | 726.7 | 18 |
| 2 | 1 | DMM | TDI | yes | yes | 8 | 606.6 | 21 |
| 3 (comp.) | 2 | — | TDI | no | no | —^{d)} | —^{d)} | —^{d)} |
| 4 (comp.) | 1 | DMM | TDI | no | no | —^{e)} | —^{e)} | —^{e)} |
| 5 | 2 | DMM | TDI | yes | yes | 9 | 636.6 | 32 |
| 6 | 2 | DMM | HDI | yes | yes | 8 | 606.6 | 16 |
| 7 | 2 | DMM | IPDI | yes | yes | 10 | 762.6 | 17 |
| 8 (comp.) | 1 | Dioxane, | TDI | — | — | — | — | —^{f} |
| | | Benzene | | | | | | |

^{a)}step ii) withdrawing the formaldehyde solution prepared in step i) from the first container and transferring it to a second container containing OH-reactive compound,
^{b)}step iii) distillatively recycling the solvent from the second container to the first container,
^{c)}number-average number of polyoxymethylene repeating units,
^{d)}white solid comprising complex mixture which cannot be further characterized in the first container,
^{e)}complex mixture which cannot be further characterized in the first container,
^{f}no polymers having NCO groups or NCO prepolymers present.

1. A process for preparing a prepolymer comprising a polyoxymethylene block, comprising:
i) preparing a formaldehyde solution (a) by adding a solvent to polymeric formaldehyde in a first container;
ii) withdrawing the formaldehyde solution prepared in step i) from the first container and transferring it to a second container containing OH-reactive compound to form a solution (b) containing the prepolymer;
iii) distillatively recycling the solvent from the second container to the first container;
wherein the polymeric formaldehyde has m terminal hydroxyl groups;
wherein m is a natural number of two or more,
wherein the OH-reactive compound has m terminal OH-reactive groups;
wherein the solvent contains no OH-reactive functional groups and does not itself react with OH-reactive compounds;
wherein the solution (b) in step ii) has a temperature in the second container of not more than 80° C.;
and wherein the temperature of the formaldehyde solution (a) in the first container in step i) is not more than the temperature of the solution (b) in the second container.

2. The process as claimed in claim 1, wherein in step i) the solvent is added to the first container discontinuously or continuously.

3. The process as claimed in claim 1, wherein the formaldehyde solution prepared in step ii) is withdrawn from the first container discontinuously or continuously.

4. The process as claimed in claim 1, wherein in step iii) the solvent is recycled from the second container to the first container discontinuously or continuously.

5. The process as claimed in claim 1, wherein the solvent used in step i) comprises an aprotic solvent.

6. The process as claimed in claim 5, wherein the aprotic solvent has a boiling temperature of not more than 80° C. at 1 bara.

7. The process as claimed in claim 5, wherein the aprotic solvent comprises n-pentane, n-hexane, n-heptane, petroleum ether, carbon disulfide, carbon dioxide, trichlorethylene, methylene chloride, carbon tetrachloride, chloroform, trichlorofluoromethane, tetrabromomethane, bromodichloromethane, fluorobenzene, 1,4-difluorobenzene, dichlorofluoromethane, difluorodichloromethane, chlorodifluoromethane, ethyl acetate, isopropyl acetate, methyl formate, ethyl formate, isopropyl formate, propyl formate, acetaldehyde dimethyl acetal, acetonitrile, methyl tert-butyl ether, tert-butyl ethyl ether, tert-amyl methyl ether, methyl propyl ether, sec-butyl methyl ether, butyl methyl ether, methyl n-propyl ether, 1-ethoxypropane, 1,3-dioxolane, 1,1-dimethoxyethane, diisopropyl ether, 2-methyl-tetrahydrofuran, 2,2-dimethoxypropane, dimethyl ether, dimethoxymethane, ethyl methyl ether, diethyl ether, diethoxymethane, dimethoxyethane, tetrahydrofuran, 1,4,7,10-tetraoxacyclododecane ([12]crown-4), acetone, methyl ethyl ketone, or a combination of any two or more thereof.

8. The process as claimed in claim 1, wherein the OH-reactive compound comprises a dicarboxylic acid, a tricarboxylic acid, a dicarboxylic acid chloride, a tricarboxylic acid chloride, a dicarboxylic acid azide, a tricarboxylic acid azide, a dicarboxylic acid anhydride, a tricarboxylic acid anhydride, an organic diazide, an organic triazide, a diepoxide, a triepoxide, a halomethyloxirane, a diaziridine, a triaziridine, a disilyl chloride, a trisilyl chloride, a disilane, a trisilane, an n-alkyldi(magnesium halide), an n-alkyltri(magnesium halide), a disulfonyl chloride, a trisulfonyl chloride, an organic di(chlorosulfite), an organic tri(chlorosulfite), an organic di(phosphorus dibromide), an organic tri(phosphorus dibromide), a polythiocyanate, a polyisocyanate, or a combination of any two or more thereof.

9. The process as claimed in claim 8, wherein the OH-reactive compound comprises a polyisocyanate and the reaction is performed at an NCO index of ≥100 to ≤5000 to afford an NCO-terminated prepolymer.

10. The process as claimed in claim 9, wherein the polyisocyanate comprises 1,4-diisocyanatobutane, 1,5-diisocyanatopentane, 1,6-diisocyanatohexane, 2-methyl-1,5-diisocyanatopentane, 1,5-diisocyanato-2,2-dimethylpentane, 2,2,4-trimethyl-1,6-diisocyanatohexane, 2,4,4-trimethyl-1,6-diisocyanatohexane, 1,10-diisocyanatodecane, 1,3-diisocyanatocyclohexane, 1,4-diisocyanatocyclohexane, 1,3-bis(isocyanatomethyl)cyclohexane, 1,4-bis(isocyanatomethyl)cyclohexane, 1-isocyanato-3,3,5-trimethyl-5-isocyanatomethylcyclohexane, 4,4′-diisocyanatodicyclohexylmethane, 4-isocyanatomethyl-1,8-octane diisocyanate, ω,ω′-diisocyanato-1,3-dimethylcyclohexane, 1-isocyanato-1-methyl-3-isocyanatomethylcyclohexane, 1-isocyanato-1-methyl-4-isocyanatomethylcyclohexane, bis(isocyanatomethyl)norbornane, 1,5-naphthalene diisocyanate, 1,3-bis(2-isocyanato-prop-2-yl)benzene, 1,4-bis(2-isocyanato-prop-2-yl)benzene, 2,4-diisocyanatotoluene, 2,6-diisocyanatotoluene, 2,4′-diisocyanatodiphenylmethane, 4,4′-diisocyanatodiphenylmethane, 1,5-diisocyanatonaphthalene, 1,3-bis(isocyanatomethyl) benzene, any desired mixtures of any two or more of the foregoing compounds, polyfunctional isocyanates obtained by dimerization or trimerization or higher oligomerization of any of the foregoing isocyanates containing isocyanurate rings, iminooxadiazinedione rings, uretdione rings, urethonimine rings, or a combination of any two or more thereof, polyfunctional isocyanates obtained through adduct formation of any of the foregoing isocyanates onto mixtures of different more than difunctional alcohols, or a combination of any two or more thereof.

11. A prepolymer comprising polyoxymethylene block prepared as claimed in claim 1, having a number-average number of polyoxymethylene repeating units of 2 to 50, wherein the number of polyoxymethylene repeating units is determined by proton resonance spectroscopy.

12. The prepolymer comprising polyoxymethylene block as claimed in claim 11, wherein the prepolymer comprising polyoxymethylene block is an NCO-terminated prepolymer having a content of reactive isocyanate groups of ≥4% by weight to ≤25% by weight based on the mass of the prepolymer comprising polyoxymethylene block of the isocyanate groups in the prepolymer comprising polyoxymethylene block, wherein the content of reactive isocyanate groups is determined by NMR spectroscopy by derivatization with methanol.

13. A mixture comprising the prepolymer comprising polyoxymethylene block as claimed in claim 11 and an OH-reactive compound.

14. The mixture as claimed in claim 13, wherein the mixture has a content of reactive isocyanate groups of ≥4% by weight to ≤50% by weight based on the total proportion of the isocyanate groups, wherein the content of reactive isocyanate groups is determined by NMR spectroscopy by derivatization with methanol.

15. An industrial chemical process for preparing a product of defined composition comprising:
i) preparing, in a first container, a reactant solution by adding a solvent to a reactant having a solubility of <1 g/L and a melting point not less than its decomposition point,
ii) withdrawing the reactant solution prepared in step i) from the first container and transferring it to a second container containing a compound reactive with the reactant to form a solution containing the product, and
iii) distillatively recycling the solvent from the second container into the first container,
wherein the solution containing the product in step ii) has a temperature in the second container of not more than 150° C.;
wherein the temperature in the first container in step i) is not more than the temperature in the second container;
and wherein the solvent does not react with the reactant, the compound reactive with the reactant and the product.
